(19) United States
(12) Patent Application Publication
(10) Pub. No.: US 2025/0271079 A1
(43) Pub. Date: Aug. 28, 2025

(54) VALVE STATUS INDICATION DEVICE

(71) Applicant: EMERSON PROCESS MANAGEMENT CHENNAI PRIVATE LIMITED, Chengalpattu (IN)

(72) Inventors: Soundharrajan Sachidanandam, Chennai (IN); Senthil Ashokkumar, Chennai (IN); Nilesh Vidyadhar Puntambekar, Pune (IN)

(73) Assignee: EMERSON PROCESS MANAGEMENT CHENNAI PRIVATE LIMITED, Chengalpattu (IN)

(21) Appl. No.: 19/058,566

(22) Filed: Feb. 20, 2025

(30) Foreign Application Priority Data
Feb. 26, 2024 (IN) 202441013782

(51) Int. Cl. F16K 37/00; F16K 11/07

(52) U.S. Cl. CPC F16K 37/0008; F16K 37/0058; F16K 11/07

(57) ABSTRACT

A valve status indication device is configured with a spool having a pin fitted thereon and further configured to trigger movement of the pin corresponding to the valve's energized state or de-energized state. The device is configured to be mounted on the valve in fluid communication to the pin, and provides a visual indication corresponding to the valve's state. The device includes a housing mounted to the valve, the piston configured to be displaced corresponding to the pin, the arm displaced with the piston, a first dial and a second dial configured to be pivotally mounted within the housing, and further configured with a label to indicate de-energized and energized state of the valve. The arm is mounted to first dial and the second dial which angularly displaces to provide a real-time visual indication of valve's state.

### FIELD

The present disclosure relates to the field of valve status indication devices.

### Definition

As used in the present disclosure, the following terms are generally intended to have the meaning as set forth below, except to the extent that the context in which they are used indicate otherwise.

Energized state of valve—The term ‘Energized state’ refers to a state of the valve in which a displaceable valve element of the valve does not occupy its seat and a process fluid is passed therethrough.

De-energized state of valve—The term ‘De-energized state’ refers to a state of the valve in which a displaceable valve element of the valve occupies its seat and a process fluid is restricted from passing therethrough.

### BACKGROUND

The background information herein below relates to the present disclosure but is not necessarily prior art.

Valves play a crucial role in regulating the flow of fluids within various industrial processes. Typically, these valves are equipped with a spool mechanism that is activated or displaced from its neutral or mean position when the valve is energized, and it returns to its neutral position when the valve is not energized or de-energized. However, traditional valves lack any indication means of whether they are in an energized or de-energized state, necessitating manual inspection to determine their status.

Moreover, if the spool of the valve becomes stuck, it becomes challenging to ascertain whether the valve is operational or not, leading to potential malfunctions that can disrupt the production processes. This situation not only impacts production efficiency but also compromises the safety of workers, especially considering that these valves often control fluids under high pressure.

Additionally, there's absence of visual indication devices which can facilitates seamless mounting onto the conventional or traditional valves to facilitate the feedback of the spool movement under the action of fluid pressure. Consequently, the entire valve assembly must be replaced, resulting in increased assembly and labour costs.

There is, therefore, felt a need of, a valve status indication device that alleviates the above-mentioned drawbacks.

### Objects

Some of the objects of the present disclosure, which at least one embodiment herein satisfies, are as follows:

An object of the present disclosure is to provide a valve status indication device that eliminates direct contact of process fluid handled by the valve with the device.

Another object of the present disclosure is to provide a valve status indication device that facilitates visual feedback of the valve state in real-time.

Still another object of the present disclosure is to provide a valve status indication device that facilitates ease of mounting with the spool valves.

Yet another object of the present disclosure is to provide a valve status indication device that can be retrofitted onto existing valves without the need for extensive modifications or valve replacement.

Another object of the present disclosure is to provide a valve status indication device that is smooth in operation.

Yet another object of the present disclosure is to provide a valve status indication device that detects the potential malfunctions of the valve spool before they disrupt operations, allowing for proactive maintenance and minimizing downtime.

Other objects and advantages of the present disclosure will be more apparent from the following description, which is not intended to limit the scope of the present disclosure.

### SUMMARY

The present disclosure envisages a valve status indication device. The valves status indication device retrofits to a valve. The valve is configured with a spool having a pin fitted thereon. The valve is further configured to trigger movement of the pin corresponding to the energized state or de-energized state of the valve. The device is configured to be mounted on an operative front end of the valve and in fluid communication to the pin. The device is further configured to provide a visual indication corresponding to the valve's state. The device comprises a housing configured to be mounted on the operative front end of the valve. A piston is configured to be hermitically sealed within the housing. The piston is further configured to be in communication with the pin. The piston is configured to be displaced corresponding to the movement of the pin. An arm is configured to be mounted on an operative front portion of the piston. The arm is further configured to extend longitudinally within the housing. The arm is configured to be operatively displaced with the movement of the piston. A first dial is configured to be pivotally mounted within the housing, and further configured with a label to indicate de- energized state of the valve. A second dial is configured to be pivotally mounted within the housing, and further configured with a label to indicate energized state of the valve. An operative end of the arm is configured to be coaxially mounted to an operative portion of the first dial and the second dial. The first dial and the second dial are configured to be angularly displaced within the housing corresponding to the movement of the piston to provide a real-time visual indication of the valve's energized state or de-energized state in an operative configuration of the device.

In a preferred embodiment, the first dial and the second dial is configured to be coaxially mounted within the housing.

In a preferred embodiment, the device includes a spring connected between the piston and the housing to selectively bias the arm in one of its positions.

In a preferred embodiment, the housing is configured to be detachably attached to the valve body.

In a preferred embodiment, the pin is detachably attached to the spool.

In a preferred embodiment, the housing is configured with a transparent visor, the first dial or the second dial is configured to be selectively positioned within the visor space to facilitate clear visual indication of the valve's energized or de-energized state.

In a preferred embodiment, the piston is configured to be displaced from a mean position to an extreme position in response to the pin's movement. The mean position of the piston defines the de-energized state of the valve and the extreme position of the piston defines the energized state of the valve. Displacement of the piston from the mean position to the extreme position is configured to push the first dial out of the visor space while simultaneously moving the second dial within the visor space to provide the visual indication of the valve's status.

### BRIEF DESCRIPTION OF THE ACCOMPANYING DRAWING

A valve status indication device, of the present disclosure will now be described with the help of the accompanying drawing, in which:

FIG. 1 shows an isometric view of the valve status indicator device, in accordance with an embodiment of the present disclosure;

FIG. 2 shows an exploded view of the valve status indicator device of FIG. 1;

FIG. 3 shows a cross sectional view of FIG. 1 depicting the de-energized state of the device;

FIG. 4 shows a cross sectional view of FIG. 1 depicting the energized state of the device;

FIG. 5 shows a detail of FIG. 4; and

FIG. 6 shows a cross sectional view of FIG. 1 depicting the plurality of balls in the de-energized state of the device.

### LIST OF REFERENCE NUMBERS USED IN DETAILED DESCRIPTION AND DRAWINGS

10—pin
12—operative front portion of piston
20—arm
30—first dial
32—second dial
40—spring
50—spool
60—visor
70—balls
110—piston
200—valve body
210—operative front end of valve
300—housing
500—valve indicator device
1000—valve
L—operative longitudinal direction

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “mounted on”, “engaged to”, “connected to”, or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third, etc., when used herein do not imply a specific sequence or order unless clearly suggested by the present disclosure.

Terms such as “inner,” “outer,” “beneath,” “below,” “lower,” “above,” “upper,” and the like, may be used in the present disclosure to describe relationships between different elements as depicted from the figures.

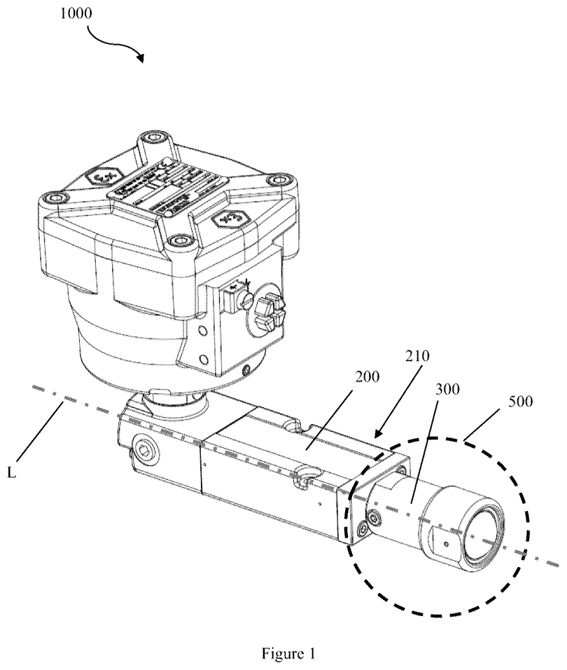

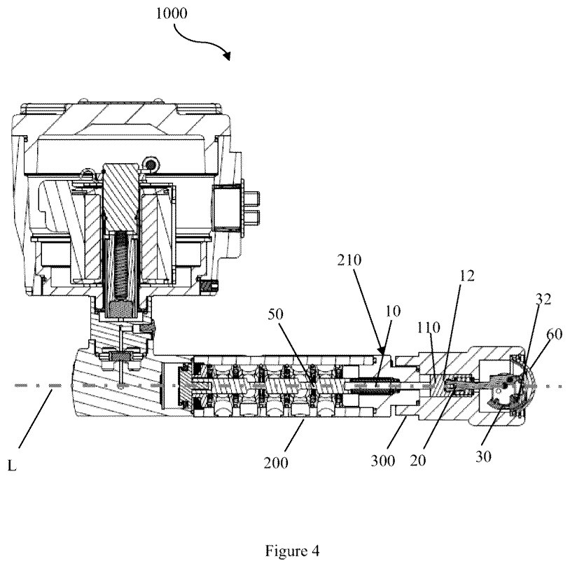

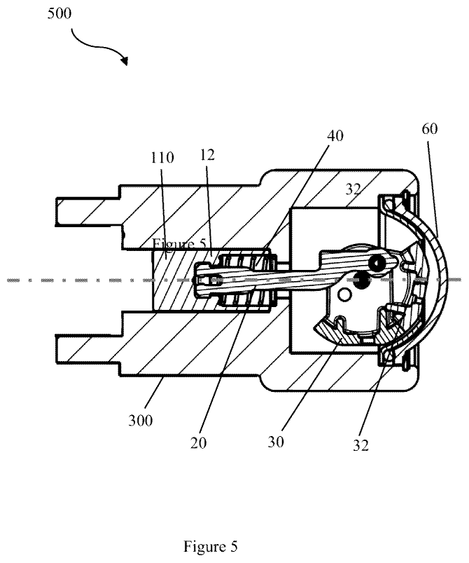

The different embodiments of the present disclosure are explained with reference to FIG. 1 to FIG. 6.

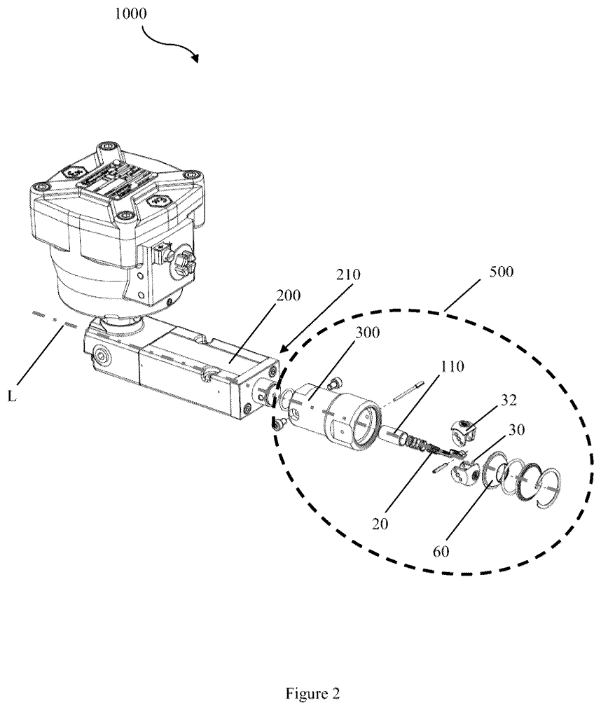

In accordance with the FIG. 1, a valve status indication device 500 (herein after referred as an indication device 500) for a valve will now be described. The device 500 is retrofitted to an operative front end of the valve 1000. This facilitates detachable attachment of the device 500 to the valve 1000. Thus, the device 500 can be used on a variety of valve applications. The FIG. 1 shows an isometric view of the valve status indicator device, in accordance with an embodiment of the present disclosure. FIG. 2 shows an exploded view of the valve status indicator device of FIG. 1.

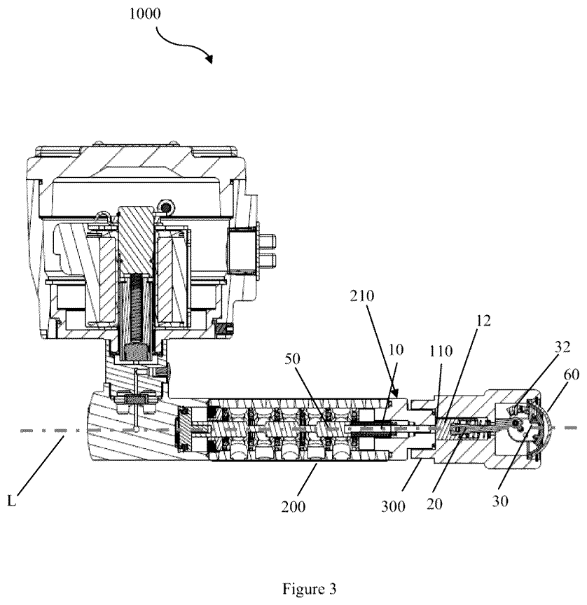

In accordance with the FIG. 3-FIG. 6, the valve 1000 is configured with a spool 50 having a pin 10 fitted thereon. The valve 1000 is further configured to trigger movement of the pin 10 corresponding to an energized state or a de-energized state of the valve 1000 with respect to variation in pressure of the fluid in communication. The device 500 is configured to be mounted on an operative frond end of the valve 1000 which is in fluid communication with the pin 10. Thus, the fluid pressure of the valve 1000 actuates the pin 10. As shown in FIGS. 3-6, the pin 10 is linearly displaced. The device 500 is further configured to provide a visual indication corresponding to the energized state and the de-energized state of the valve 1000. The device 500 comprises a housing 300, a piston 110, an arm 20, a first dial 30, a second dial 32.

The piston 110 is configured to be hermitically sealed within the housing 300, and further configured to be in communication with the pin 10. The piston 110 is configured to be displaced from a mean position to an extreme position in response to the pin's 10 movement. The mean position of the piston 110 defines the de-energized state of the valve 1000 and the extreme position of the piston 110 defines the energized state of the valve 1000. In the embodiment as shown in FIGS. 1-6, the piston 110 is mechanically or pneumatically coupled to the pin 10. As the piston 110 is hermetically sealed within the housing 300, the fluid pressure of the valve 1000 is prevented from being directly getting into contact with the device 500. This avoids unnecessary interference of the process fluid handled by the valve 1000 with the device 500 that indicates the state of the valve 1000. Additionally, chances of leakage of the process fluid through the valve indicator device 500 are eliminated, thus imparting safety to the valve indicator device 500. Thus, an indirect actuation of the piston 110 is achieved. The piston 110 is configured to be displaced corresponding to the movement of the pin 10. Thus, the movement of the pin 10 is transferred to the piston 110.

The arm 20 is configured to be mounted on an operative front portion 12 of the piston 110, and further configured to extend longitudinally within the housing 300. The arm 20 is configured to be operatively displaced with the movement of the piston 110. The arm 20 facilitates spanning the device 500 in the operative longitudinal direction L.

The first dial 30 is configured to be pivotally mounted within the housing 300, and further configured with a label to indicate de-energized state of the valve 1000. The first dial 30 provides a clear indication of the de-energized state of the valve 1000.

The second dial 32 is configured to be pivotally mounted within the housing 300, and further configured with a label to indicate energized state of the valve 1000. The second dial 32 provides a clear indication of the de-energized state of the valve 1000.

In another embodiment, the first dial 30 and the second dial 32 are color-coded to increase the clarity of the visual feedback.

An operative end of the arm 20 is configured to be coaxially mounted to an operative portion of the first dial 30 and the second dial 32. Thus, the movement of the arm 20 is transferred to the first dial 30 and the second dial 32 for providing indication of the state of the valve 1000.

The first dial 30 and the second dial 32 are configured to be angularly dsiplaced within the housing 300, corresponding to the movement of the piston 110 to provide a real-time visual indication of the valve's 1000 energized state or the de-energized state in an operative configuration of the device 500.

In an embodiment as shown in FIGS. 2-5, the first dial 30 and the second dial 32 are configured to be coaxially mounted within the housing 300.

The device 500 includes a spring 40 connected between the piston 110 and the housing 300 to selectively bias the arm 20 in one of its positions corresponding either to the energized state or the de-energized state of the valve 1000. The arm 20 returns to its biased position with the help of the spring 40.

In a preferred embodiment of the device 500, the housing 300 is configured to be detachably attached to the valve body 200. This facilitates interchangeability of the device 500 with the valve 1000 when the valve 1000 is not in operation, or when the device 500 is needed to be attached to another valve at an altogether different location.

In a preferred embodiment of the device 500, the pin 10 is detachably attached to the spool 50 of the valve 1000. This facilitates retrofitting of the valve indication device 500 on a number of valves.

The housing 300 is configured with a transparent visor 60. The first dial 30 or the second dial 32 is configured to be selectively positioned within the visor space 60 to facilitate clear visual indication of the valve's 1000 energized or de-energized state. The transparent visor 60 provides a visual indication of the state of the spool 50. The visor 60 facilitates sight of the first dial 30 and the second dial 32 to provide a visual indication of the state of the valve 1000. The displacement of the piston 110 from the mean position to the extreme position is configured to push the first dial 30 out of the visor space 60 while simultaneously moving the second dial 32 within the visor space 60 to provide the visual indication of the valve's 1000 status. In the event, the spool 50 gets stuck due to malfunctioning thereof, the same is indicated by the first dial 30 and the second dial 32. This alerts the personnel working with the valve 1000, thereby prompting them for a desired action to be performed on the valve indication device 500. Easy confirmation of the valve status is obtained via the visual feedback.

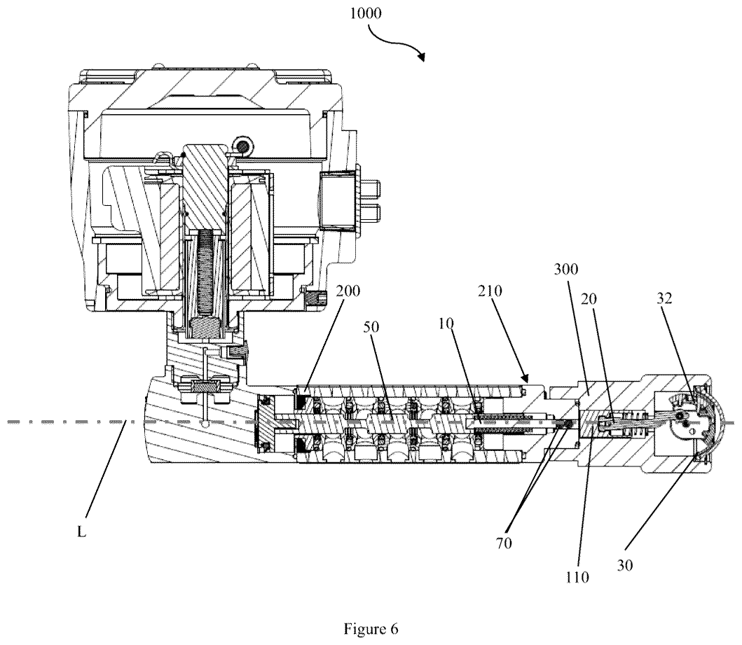

In another embodiment of the present disclosure as shown in FIG. 6, the first dial 30 and the second dial 32 are integrated with the spool 50 through the connections of the piston 110, the pin 10, a plurality of balls 70 and the housing 300. The movement of the spool 50 and the pin 10 will be transferred to the piston 110 via the plurality of balls 70. The balls 70 facilitate point contact with the piston 110. As point contact reduces friction between mating parts, smoothness of operation is observed.

In an embodiment, the valve 1000 is a solenoid operated valve.

In another embodiment, the valve 1000 is an air operated valve and thus the device 500 is pneumatically actuated by mean of air pressure.

In an embodiment, the housing 300 is made of stainless steel, the arm, the first dial and the second dial are made of a polymeric material.

In an embodiment, the device 500 is snap fitted on to the front portion of the valve 1000. In another embodiment, the device 500 is rotatably fitted on to the operative portion of the valve 1000.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### Technical Advancement

The present disclosure described herein above has several technical advantages including, but not limited to, a valve status indication device that:
eliminates direct contact of process fluid handled by the valve with the device;
offers easy confirmation of valve status via visual feedback;
facilitates ease of mounting with the spool valves;
can be easily retrofit onto existing valves without the need for extensive modifications or valve replacement, thereby reducing installation costs; and
point contact offered by the balls reduces friction and results in smooth operation of the device; and.
detects the potential malfunctions of the valve spool before they disrupt operations, allowing for proactive maintenance and minimizing downtime.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, or step, or group of elements, or steps, but not the exclusion of any other element, or step, or group of elements, or steps.

The use of the expression “at least” or “at least one” suggests the use of one or more elements or ingredients or quantities, as the use may be in the embodiment of the disclosure to achieve one or more of the desired objects or results.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A valve status indication device, the valve being configured with a spool having a pin fitted thereon and further configured to trigger movement of the pin corresponding to the valve's energized state or de-energized state, said device configured to be mounted on an operative frond end of the valve in fluid communication to the pin, and further configured to provide a visual indication corresponding to the valve's state, said device comprising:
a housing configured to be mounted on the operative front end of the valve;
a piston configured to be sealed within said housing, and further configured to be in communication with the pin, said piston configured to be displaced corresponding to the movement of the pin;
an arm configured to be mounted on said piston, and further configured to extend longitudinally within said housing, said arm configured to be operatively displaced with the movement of said piston;
a first dial provided in said housing, and configured to indicate de-energized state of the valve; and
a second dial provided in said housing, and configured to indicate energized state of the valve,
wherein said first dial and said second dial are configured to be angularly displaced within said housing corresponding to the movement of said piston to provide a real-time visual indication of the valve's energized state or de-energized state in an operative configuration of said device.

2. The device as claimed in claim 1, wherein an operative end of said arm is configured to be coaxially mounted on an operative portion of said first dial and said second dial.

3. The device as claimed in claim 2, wherein said first dial and said second dial is configured to be coaxially mounted within said housing.

4. The device as claimed in claim 1 includes a spring connected between the piston and the housing to selectively bias the arm in one of its positions.

5. The device as claimed in claim 1, wherein said housing is configured to be detachably attached to the valve body.

6. The device as claimed in claim 1, wherein said pin is detachably attached to the spool.

7. The device as claimed in claim 1, wherein said housing is configured with a transparent visor, said first dial or said second dial is configured to be selectively positioned within said visor space to facilitate clear visual indication of the valve's energized or de-energized state.

8. The device as claimed in claim 6, wherein said piston is configured to be displaced from a mean position to an extreme position in response to the pin's movement.

9. The device as claimed in claim 8, wherein said mean position of said piston defines the de-energized state of the valve and said extreme position of said piston defines the energized state of the valve.

10. The device as claimed in claim 9, wherein displacement of said piston from said mean position to said extreme position is configured to push said first dial out of said visor space while simultaneously moving said second dial within said visor space to provide the visual indication of the valve's status.

11. The device as claimed in claim 1, wherein said piston is configured to be hermetically sealed within said housing.

12. The device as claimed in claim 1, wherein said arm is configured to be mounted on an operative front portion of said piston.

13. The device as claimed in claim 1, wherein said first dial is configured to be pivotally fitted within said housing.

14. The device as claimed in claim 1, wherein said second dial is configured to be pivotally fitted within said housing.
